(19) United States
(12) Patent Application Publication
(10) Pub. No.: US 2022/0181677 A1
(43) Pub. Date: Jun. 9, 2022

(54) LITHIUM ION SECONDARY BATTERY

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/456,589

(22) Filed: Nov. 25, 2021

(30) Foreign Application Priority Data
Dec. 3, 2020 (JP) 2020-201040

(51) Int. Cl. H01M 10/0562; H01M 4/80; H01M 10/0525; H01M 10/0585; H01M 10/0566

(52) U.S. Cl. CPC H01M 10/0562; H01M 4/80; H01M 10/0566; H01M 10/0585; H01M 10/0525

(57) ABSTRACT

To provide a lithium ion secondary battery that allows the cell state to be monitored by arranging a reference electrode, even in a solid-state battery. In a lithium ion secondary battery 50, a positive electrode 1, a reference electrode 3, and a negative electrode 2 are arranged in this sequence. The positive electrode 1 includes a first current collector 11 including a metal porous body, and a first electrode material mixture 15 with which pores of the first current collector 11 are filled. The negative electrode 2 includes a second current collector 21 including a metal porous body, and a second electrode material mixture 25 with which pores of the second current collector 21 are filled. The reference electrode 3 includes a third current collector 31 including a metal porous body, and a solid electrolyte 35 with which pores of the third current collector 31 are filled.

This application is based on and claims the benefit of priority from Japanese Patent Application No. 2020-201040, filed on 3 Dec. 2020, the content of which is incorporated herein by reference.

### BACKGROUND OF THE INVENTION

### Field of the Invention

The present invention relates to a lithium ion secondary battery.

### Related Art

Conventionally, lithium ion secondary batteries have been widely used as secondary batteries having a high energy density. A liquid lithium ion secondary battery has a cell structure in which a separator is present between a positive electrode and a negative electrode and the cell is filled with a liquid electrolyte (electrolytic solution). In the case of an all-solid-state battery where the electrolyte is solid, the battery has a cell structure in which a solid electrolyte is present between a positive electrode and a negative electrode. A plurality of the cells are stacked to construct a lithium ion secondary battery.

In a lithium ion secondary battery cell, a reference electrode (also referred to as a standard electrode) may be arranged between a positive electrode and a negative electrode for the purpose of monitoring the cell state in detail. For example, in a lithium ion secondary battery in which the electrolyte is liquid, a reference electrode is arranged between separators (see Patent Document 1).

On the other hand, to increase the filling density of an electrode active material, it has been proposed to use metal porous bodies as current collectors respectively constituting a positive electrode layer and a negative electrode layer (for example, see Patent Document 2). The metal porous body has a network structure with pores and a large surface area. Filling the interior of the network structure with an electrode material mixture including an electrode active material enables the amount of the electrode active material per unit area of the electrode layer to be increased.
Patent Document 1: Japanese Unexamined Patent Application, Publication No. 2013-191532
Patent Document 2: Japanese Unexamined Patent Application, Publication No. 2012-186139

### SUMMARY OF THE INVENTION

When the electrolyte is liquid, as in Patent Document 1, a reference electrode can be arranged between separators. However, in the case of a solid-state battery, since the electrolyte is solid and therefore hard, it is not as easy to arrange a reference electrode in the electrolyte as in a liquid electrolyte.

It is possible to place metal wires or the like in the solid electrolyte layer. However, in the case of a solid-state battery, since a pressing step is required when the cells are stacked, stress concentrates on the metal wire portions, and the solid electrolyte layer may be destroyed by vibration or the like, causing a short circuit.

In response to the above issue, it is an object of the present invention to provide a lithium ion secondary battery that allows the cell state to be monitored by arranging a reference electrode, particularly in a solid-state battery.

(1) A first aspect of the present invention relates to a lithium ion secondary battery, including a positive electrode, a reference electrode, and a negative electrode. The positive electrode, the reference electrode, and the negative electrode are arranged in this sequence. The positive electrode includes a first current collector including a metal porous body, and a first electrode material mixture with which at least pores of the first current collector are filled. The negative electrode includes a second current collector including a metal porous body, and a second electrode material mixture with which at least pores of the second current collector are filled. The reference electrode includes a third current collector including a metal porous body, and an electrolyte with which at least pores of the third current collector are filled.

According to the invention of the first aspect, the reference electrode includes the third current collector including the metal porous body, and the electrolyte with which the pores of the metal porous body are filled. The metal porous body has a three-dimensional network structure. This prevents the metal porous body from being destroyed in a pressing step and enables the electrode function as a reference electrode to be provided. At the same time, the electrolyte with which the pores of the metal porous body is filled, can perform the function of a conventional electrolyte layer. That is, the reference electrode of the present invention functions as a reference electrode and an electrolyte layer.

(2) In a second aspect of the present invention according to the first aspect, an electrolyte layer is formed between the positive electrode and the reference electrode and/or between the reference electrode and the negative electrode.

According to the invention of the second aspect, providing yet another electrolyte layer between each of the electrodes reliably prevents short circuits between both of the electrodes and the reference electrode.

(3) In a third aspect of the present invention according to the first or second aspect, the electrolyte or the electrolyte layer includes a solid electrolyte or a solid electrolyte layer.

According to the invention of the third aspect, a reference electrode can be formed even in a solid-state battery in which the arrangement of a reference electrode has been conventionally difficult.

(4) In a fourth aspect of the present invention according to any one of the first to third aspects, the third current collector has a larger porosity than the first and second current collectors.

(5) In a fifth aspect of the present invention according to any one of the first to fourth aspects, the third current collector has a smaller wire cross-sectional area than the first and second current collectors.

According to the inventions of the fourth and fifth aspects, increasing the porosity or decreasing the wire cross-sectional area of the third current collector enables the region of the electrolyte to be relatively expanded, and thus the function of the electrolyte can be fully performed.

(6) in a sixth aspect of the present invention according to any one of the first to fifth aspects, a third tab extending from the reference electrode is thinner than tabs respectively extending from the positive and negative electrodes. A third tab convergence portion extending from the reference electrode is thinner than tab convergence portions respectively extending from the positive and negative electrodes.

According to the invention of the sixth aspect, since the third current collector is a reference electrode, it is only necessary to be able to monitor the voltage. There is no problem in the electrode function even if the thicknesses of the tab and the tab convergence portion extending from the reference electrode are made thin. This allows the reference electrode to be thin and the cell to be compact.

(7) In a seventh aspect of present invention according to any one of the first to sixth aspects, the third current collector includes copper, and the electrolyte includes a sulfide solid electrolyte.

According to the invention of the seventh aspect, the standard potential of copper sulfide generated by the reaction between copper and sulfide solid electrolyte is known, and utilizing this can improve the accuracy of the reference electrode.

### BRIEF DESCRIPTION OF THE DRAWINGS

FIG. 1 is a cross-sectional schematic diagram of a lithium ion secondary battery according to an embodiment of the present invention;

FIG. 2A is an enlarged cross-sectional view of a positive electrode in FIG. 1;

FIG. 2B is an enlarged cross-sectional view of a negative electrode in FIG. 1;

FIG. 2C is an enlarged cross-sectional view of a reference electrode in FIG. 1;

FIG. 3A is a schematic diagram showing the cell state using the reference electrode; and

FIG. 3B is a schematic diagram showing the cell state using the reference electrode.

### DETAILED DESCRIPTION OF THE INVENTION

An embodiment of the present invention will now be described with reference to the drawings. The present invention is not limited to the description of the following embodiment.

In the following embodiment, a solid-state lithium ion battery in which the electrolyte layer is solid is described as an example, but the present invention is not limited thereto and can also be applied to a battery in which the electrolyte is liquid or a hybrid type battery in which the electrolyte is solid and liquid.

<Overall Structure of Lithium Ion Secondary Battery>

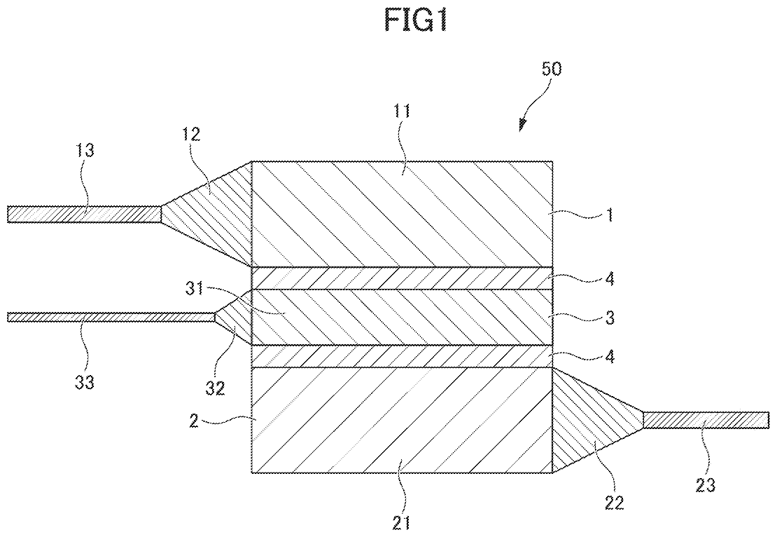

As shown in FIG. 1, in a lithium ion secondary battery of the present invention, a positive electrode 1 and a negative electrode 2 are arranged in a stack with a reference electrode 3 provided therebetween. In the lithium ion secondary battery according to this embodiment in FIG. 1, the positive electrode 1 and the reference electrode 3 are stacked via a solid electrolyte layer 4, and the reference electrode 3 and the negative electrode 2 are stacked via another solid electrolyte layer 4. That is, a cell consists of five layers: a positive electrode 1, a solid electrolyte layer 4, a reference electrode 3, a solid electrolyte layer 4, and a negative electrode 2. As the materials of the positive electrode and the negative electrode, two types of materials are selected from materials capable of constituting electrodes. The charge-discharge electric potentials of the two types of compounds are compared, the material exhibiting a higher electric potential is used in the positive electrode, the material exhibiting a lower electric potential is used in the negative electrode, and thereby any battery can be constructed. The structure of each of the electrodes is described below.

<Positive Electrode and Negative Electrode>

The positive electrode 1 and the negative electrode 2 respectively include metal porous bodies each having pores that are continuous with each other (communicating pores), and are respectively provided with a first current collector 11 and a second current collector 21, which are substantially rectangular in plan view, except for tab convergence portions and tabs.

In the stacked state shown in FIG. 1, a tab convergence portion 12 that reduces in diameter, extends from one end of the first current collector 11, and further a linear tab 13 extends from the end having a reduced diameter of the tab convergence portion 12.

Similarly, a tab convergence portion 22 that reduces in diameter, extends from the other end of the second current collector 21, and further a tab 23 extends from the end having a reduced diameter of the tab convergence portion 22.

The pores of the first current collector 11 and the second current collector 21 are respectively filled with an electrode material mixture (positive electrode material mixture) 15 and an electrode material mixture (negative electrode material mixture) 25, which each contain an electrode active material. Conversely, the tab convergence 12 and the tab 13, and the tab convergence 22 and the tab 23 are regions that are not filled with the electrode material mixtures.

(Current Collector)

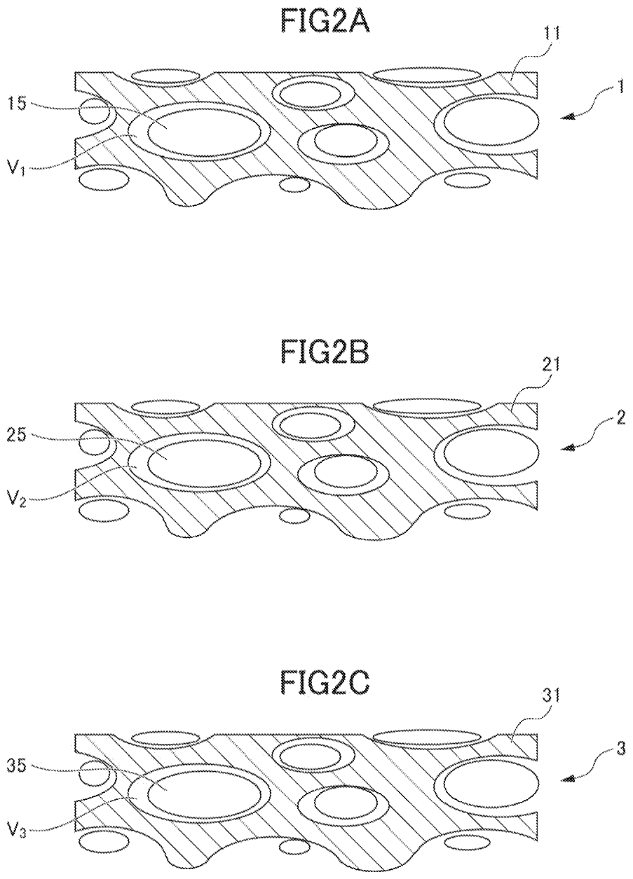

FIGS. 2A, 2B, and 2C are an enlarged cross-sectional views of the positive electrode, negative electrode, and reference electrode in FIG. 1. Since the basic structure is the same in all electrodes, the explanation is given below using the example of the positive electrode 1, and the example of the negative electrode is indicated in FIG. 2B and its explanation is omitted. As shown schematically in FIG. 2A, the first current collector 11 constituting the positive electrode current collector and the second current collector 21 constituting the negative electrode current collector each include a metal porous body having pores V that are continuous with each other. Since the first current collector 11 and the second current collector 21 have pores V that are continuous with each other, the pores V can be filled with a positive electrode material mixture 15 and a negative electrode material mixture 25 each containing an electrode active material, and thus the amount of the electrode active material per unit area of the electrode layer can be increased. The form of the metal porous body is not limited as long as it has pores that are continuous with each other. Examples of the form of the metal porous body include a foam metal having pores by foaming, a metal mesh, an expanded metal, a punching metal, and a metal nonwoven fabric.

The metal used in the metal porous body is not limited as long as it has electric conductivity. Examples thereof include nickel, aluminum, stainless steel, titanium, copper, and silver. Among these, as the current collector constituting the positive electrode, a foamed aluminum, foamed nickel, and foamed stainless steel are preferable. As the current collector constituting the negative electrode, a foamed copper and foamed stainless steel are preferable.

By using the first current collector 11 and the second current collector 21, the amount of the active material per unit area of the electrode can be increased, and as a result, the volumetric energy density of the lithium ion secondary battery can be improved. In addition, since the positive electrode material mixture 15 and the negative electrode material mixture 25 are easily fixed, it is not necessary to thicken a coating slurry for forming the electrode material mixture layer when the electrode material mixture layer is thickened, unlike a conventional electrode including a metal foil as a current collector. Accordingly, it is possible to reduce a binder such as an organic polymer compound that has been necessary for thickening. Therefore, the capacity per unit area of the electrode can be increased, and a higher capacity of the lithium ion secondary battery can be achieved.

(Electrode Material Mixture)

The positive electrode material mixture 15, which is equivalent to a first electrode material mixture, and the negative electrode material mixture 25, which is equivalent to a second electrode material mixture, are respectively disposed in the pores V formed within the first and second current collectors 11 and 21. The positive and negative electrode material mixtures 15 and 25 respectively include a positive electrode active material and a negative electrode active material as an essential component.

(Electrode Active Material)

The positive electrode active material is not limited as long as it can occlude and release lithium ions. Examples thereof include LiCoO₂, Li(Ni_{5/10}Co_{2/10}Mn_{3/10})O₂, Li(Ni_{6/10}Co_{2/10}Mn_{2/10}) O₂, Li(Ni_{8/10}Co_{1/10}Mn_{1/10})O₂, Li(Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, Li(Ni_{1/3}Co_{1/3}Mn_{1/3})O₂, LiCoO₄, LiMn₂O₄, LiNiO₂, LiFePO₄, lithium sulfide, and sulfur.

The negative electrode active material is not limited as long as it can occlude and release lithium ions. Examples thereof include metallic lithium, lithium alloys, metal oxides, metal sulfides, metal nitrides, Si, SiO, and carbon materials such as artificial graphite, natural graphite, hard carbon, and soft carbon.

(Other Components)

The electrode material mixture may optionally include components other than an electrode active material and ionic conductive particles. The other components are not limited, and can be any components that can be used in fabricating a lithium ion secondary battery. Examples thereof include a conductivity aid and a binder. The conductivity aid of the positive electrode is, for example, acetylene black, and the binder of the positive electrode is, for example, polyvinylidene fluoride. Examples of the binder of the negative electrode include sodium carboxyl methyl cellulose, styrene-butadiene rubber, and sodium polyacrylate.

(Method for Manufacturing Positive Electrode and Negative Electrode)

The positive electrode 1 and the negative electrode 2 are each obtained by filling pores that are continuous with each other of a metal porous body as a current collector with an electrode material mixture. First, an electrode active material and, if necessary, a binder and a conductivity aid, are uniformly mixed by a conventionally known method, and thus an electrode material mixture composition adjusted to a predetermined viscosity, preferably in the form of a paste, is obtained.

Subsequently, pores of a metal porous body, which is a current collector, are filled with the above electrode material mixture composition as an electrode material mixture. The method of filling the current collector with the electrode material mixture is not limited, and is, for example, a method of filling the pores of the current collector with a slurry containing the electrode material mixture by applying pressure using a plunger-type die coater. As an alternative, the interior of the metal porous body may be impregnated with an ion conductor layer by a dipping method.

<Reference Electrode>

The reference electrode 3, which is a feature of the present invention, will be described using the schematic diagram of FIG. 2C. The reference electrode 3 includes a third current collector 31 including a metal porous body, and a solid electrolyte 35 with which at least the pores of the third current collector 31 are filled. This basic structure is obtained by arranging the solid electrolyte 35 in place of the positive electrode material mixture 15 in the structure of the positive electrode 1.

(Third Current Collector)

The third current collector 31 constituting the reference electrode 3 can be of the same structure as the first and second current collectors described above. The metal used in the metal porous body is not limited as long as it has electric conductivity. Examples thereof include nickel, aluminum, stainless steel, titanium, copper, and silver. Among these, a foamed aluminum, foamed nickel, and foamed stainless steel are preferable, as are the current collector constituting the positive electrode. As described below, when the solid electrolyte is a sulfide solid electrolyte, copper is preferable as the metal used in the metal porous body.

It is preferable that the third current collector 31 has a larger porosity than the first current collector 11 and the second current collector 21. Specifically, the porosity of the first current collector 11 and that of the second current collector 21 each are about 30% or more and 99% or less by volume, whereas the porosity of the third current collector 31 is preferably 6% or more and 99% or less. Note that the porosity of the current collector refers to the ratio of the space volume of the pores of the metal porous body to the bulk volume of the entire metal porous body.

It is preferable that the third current collector 31 has a smaller wire cross-sectional area than the first current collector 11 and the second current collector 21. Here, the wire cross-sectional area of the current collector means the thickness of the linear metal portion that constitutes the metal porous body. Specifically, the wire cross-sectional area of the first current collector 11 and that of the second current collector 21 each are 0.7 μm² or more and 0.07 mml or less, whereas the wire cross-sectional area of the third current collector 31 is preferably 0.2 μm² or more and 0.007 mm or less.

Since the third current collector is a reference electrode, it is only necessary to be able to monitor the voltage, so there is no problem in terms of electrode function even if the porosity is increased or the wire cross-sectional area is decreased. Accordingly, by increasing the porosity or decreasing the wire cross-sectional area of the third current collector, a large region that is filled with the solid electrolyte 35 can be secured, and thus the ion conduction function of the solid electrolyte 35 can be sufficiently secured.

In the reference electrode 3, a third tab convergence portion 32 extending from the third current collector 31 is preferably thinner than the tab convergence portions 12 and 22 extending from the positive and negative electrodes. A third tab 33 extending from the third tab convergence portion 32 is preferably thinner than the tabs 13 and 23 extending from the positive and negative electrodes. Since the third current collector is a reference electrode, it is only necessary to be able to monitor the voltage. Accordingly, the tab convergence portion and the tab can be made thin, and the cell thickness can be made thin and compact. Specifically, with respect to the thickness of the third tab convergence portion 32, the central thickness at a position midway (½) along the third tab convergence portion 32 in a length direction in FIG. 1 is preferably 5 μm or more and 500 μm or less, and the thickness of the third tab 33 is preferably 1 μm or more and 100 μm or less.

(Electrolyte)

The solid electrolyte 35 with which the interior of the third current collector 31 is filled, can be, for example, a conventionally known solid electrolyte. Note that the solid electrolyte includes an electrolyte in gel form. Although a solid or gel solid electrolyte is used in this embodiment, the present invention may be provided with a liquid electrolyte in which the electrolyte is dissolved in a non-aqueous solvent.

The solid electrolyte is not limited, and is, for example, a sulfide solid electrolyte material, an oxide solid electrolyte material, a nitride solid electrolyte material, or a halide solid electrolyte material. Examples of the sulfide solid electrolyte material include LPS halogens (Cl, Br, and I), Li₂S—P₂S₅, and Li₂S—P₂S₅—LiI for lithium ion batteries. The above-described “Li₂S—P₂S₅” refers to a sulfide solid electrolyte material including a raw material composition containing Li₂S and P₂S₅, and the same applies to the “Li₂S—P₂S₅—LiI”. Examples of the oxide solid electrolyte material include NASICON-type oxides, garnet-type oxides, and perovskite-type oxides for lithium ion batteries. Examples of the NASICON-type oxides include oxides containing Li, Al, Ti, P, and O (e.g., Li_{1.5}Al_{0.5}Ti_{1.5}(PO₄)₃). Examples of the garnet-type oxides include oxides containing Li, La, Zr, and O (e.g., Li₇La₃Zr₂O₁₂). Examples of the perovskite-type oxides include oxides containing Li, La, Ti, and O (e.g., LiLaTiO₃).

The electrolyte dissolved in the non-aqueous solvent is not limited, and is, for example, LiPF₆, LiBF₄, LiClO₄, LiN(SO₂CF₃), LiN(SO₂C₂F₅)₂, LiCF₃SO₃, LiC₄F₉SO₃, LiC(SO₂CF₃)₃, LiF, LiCl, LiI, Li₂S, Li₃N, Li₃P, Li₁₀GeP₂S₁₂ (LGPS), Li₃PS₄, Li₆PS₅Cl, Li₇P₂S₈I, LiₓPO_{y}N_{z} (x=2y+3z−5, LiPON), Li₇La₃Zr₂O₁₂ (LLZO), Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5}(PO₄)₃(LAGP), Li_{1+x+y}AlₓTi₂₋ₓSiyP_{3-y}O₁₂, Li_{1+x+y}Alₓ(Ti, Ge)₂₋ₓSiyP_{3-y}O₁₂, and Li₄₋₂ₓZnₓGeO₄ (LISICON). One of the above may be used alone, or two or more of the above may be used in combination.

The non-aqueous solvent included in the electrolytic solution is not limited, and examples thereof include aprotic solvents such as carbonates, esters, ethers, nitriles, sulfones, and lactones. Specifically, ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, γ-butyrolactone, and the like may be used. One of the above may be used alone, or two or more of the above may be used in combination.

(Separator)

The lithium ion secondary battery of this embodiment may include a separator, especially when a liquid electrolyte is used. The separator is located between the positive electrode and the negative electrode. The material and thickness of the separator are not limited, and any known separator that can be used for lithium ion secondary batteries, such as polyethylene or polypropylene, can be applied.

When copper is used as the third current collector 31, it is preferable that the solid electrolyte 35 is a sulfide solid electrolyte. The combination of copper and a sulfide solid electrolyte produces copper sulfide by the reaction of the two. Copper sulfide is a particularly preferable combination as a reference electrode because the standard potential is known.

Filling the pores with the solid electrolyte 35 can be performed in the same manner as filling the pores with the electrode material mixtures in the positive electrode 1 and the negative electrode 2. The pores that are continuous with each other of the metal porous body as the current collector are filled with the solid electrolyte 35. First, the solid electrolyte and, if necessary, a binder and a conductivity aid, are uniformly mixed by a conventionally known method, and thus a composition adjusted to a predetermined viscosity, preferably in the form of a paste, is obtained. Subsequently, the pores of the metal porous body, which is the current collector, are filled with the composition. The method of filling the current collector with the solid electrolyte is not limited, and is, for example, a method of filling the pores of the current collector with a slurry containing the solid electrolyte by applying pressure using a plunger-type die coater. As an alternative, the interior of the metal porous body may be impregnated with an ion conductor layer by a dipping method.

Not only are the pores of the third current collector 31 filled with the solid electrolyte 35, but also at least a surface of the third current collector 31 may be coated with the solid electrolyte 35 so as to cover the surface. This allows the solid electrolyte layer 4 described below to be formed separately and prevents short circuits between the electrodes. In the case where the third current collector 31 is exposed on the surface of the reference electrode 3, the solid electrolyte layer 4 described below is formed separately.

<Solid Electrolyte Layer>

As shown in FIG. 1, in the present invention, it is preferable that a solid electrolyte layer 4 is formed between the positive electrode 1 and the reference electrode 3 and/or a solid electrolyte layer 4 is formed between the reference electrode 3 and the negative electrode 2. Providing yet another solid electrolyte layer between each of the electrodes reliably prevents short circuits between both of the electrodes and the reference electrode.

The solid electrolyte layer 4 can be the same as the solid electrolyte 35 described above. The solid electrolyte layer 4 and the solid electrolyte 35 may have the same composition, such as material, or may have different composition.

The solid electrolyte layers 4 may be formed on the surfaces of the reference electrode 3 in advance, and then stacked with the positive electrode 1 and the negative electrode 2. Alternatively, the solid electrolyte layers 4 may be respectively formed on a surface of the positive electrode 1 and that of the negative electrode 2 in advance, and then stacked with the reference electrode 3.

Although a solid electrolyte layer is used in this embodiment, the present invention may be provided with a liquid electrolyte in which the electrolyte is dissolved in a non-aqueous solvent.

(Effect of Reference Electrode)

The present invention is characterized in that the reference electrode 3 functions as a reference electrode and an electrolyte layer. As the reference electrode, since the metal porous body has a three-dimensional network structure, the reference electrode acts as a structural material that maintains strength. Accordingly, the load on the metal porous body is dispersed even under conditions of high-pressure pressing and high constraint load, as in a solid-state battery, so that the electrode function as a reference electrode is not destroyed. At the same time, since a sufficient amount of solid electrolyte can be held in the pores of the metal porous body, the reference electrode can also play the role of a solid electrolyte that blocks electrons and allows ions to pass through. This enables the reference electrode to function as a reference electrode and an electrolyte layer while keeping the cell thickness compact in a solid-state battery.

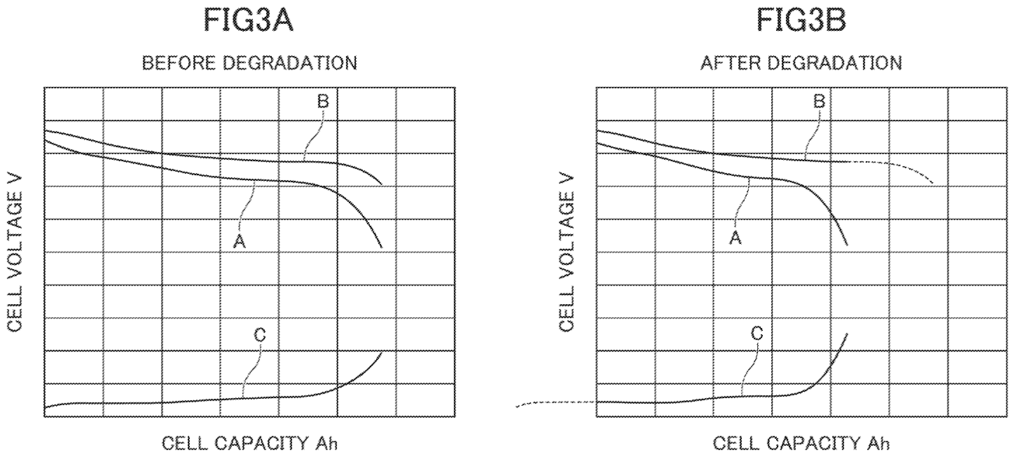

FIG. 3 is a schematic diagram showing the cell state of the lithium ion secondary battery of the present invention using the reference electrode. FIG. 3A shows the voltage monitored in the normal state, and FIG. 3B shows the voltage monitored in the degraded state. Normally, when only a line A (the potential difference between the positive and negative electrode layers) in FIG. 3A is measured, it is unclear whether the drop in charge capacity is caused by the positive or negative electrode. However, as shown in FIG. 3B, due to some factors, the range of the state of charge (SOC) used by a negative electrode C shifts, which changes the range of the SOC used by a positive electrode B, resulting in a decrease in the capacity exhibited by a battery A. In this case, performing either charging, discharging, or charging and discharging to adjust so that the negative electrode C reaches the correct SOC enables the capacity to be appropriately adjusted according to the degraded state and to be revived safely and efficiently.

A preferred embodiment of the present invention has been described above, but the present invention is not limited to the above embodiment and can be modified as appropriate.

### EXPLANATION OF REFERENCE NUMERALS

1 positive electrode
11 first current collector (positive electrode current collector)
12 first tab convergence portion
13 first tab
15 first electrode material mixture (positive electrode material mixture)
2 negative electrode
21 second current collector (positive electrode current collector)
22 second tab convergence portion
23 second tab
25 second electrode material mixture (positive electrode material mixture)
3 reference electrode
31 third current collector (positive electrode current collector)
32 third tab convergence portion
33 third tab
35 solid electrolyte
4 solid electrolyte layer
50 lithium ion secondary battery
V₁, V₂, V₃ pore

What is claimed is:

1. A lithium ion secondary battery, comprising: a positive electrode; a reference electrode; and a negative electrode, the positive electrode, the reference electrode, and the negative electrode being arranged in this sequence,
the positive electrode comprising a first current collector including a metal porous body, and a first electrode material mixture with which at least pores of the first current collector are filled,
the negative electrode comprising a second current collector including a metal porous body, and a second electrode material mixture with which at least pores of the second current collector are filled, and
the reference electrode comprising a third current collector including a metal porous body, and an electrolyte with which at least pores of the third current collector are filled.

2. The lithium ion secondary battery according to claim 1, wherein an electrolyte layer is formed between the positive electrode and the reference electrode and/or between the reference electrode and the negative electrode.

3. The lithium ion secondary battery according to claim 1, wherein the electrolyte comprises a solid electrolyte.
$$H 1203491 US 01 ( HNDF \text{-} 546 US )$$

4. The lithium ion secondary battery according to claim 2, wherein the electrolyte layer comprises a solid electrolyte layer.

5. The lithium ion secondary battery according to claim 1, wherein the third current collector has a larger porosity than the first and second current collectors.

6. The lithium ion secondary battery according to claim 1, wherein the third current collector has a smaller wire cross-sectional area than the first and second current collectors.

7. The lithium ion secondary battery according to claim 1,
wherein a third tab extending from the reference electrode is thinner than tabs respectively extending from the positive and negative electrodes, and
wherein a third tab convergence portion extending from the reference electrode is thinner than tab convergence portions respectively extending from the positive and negative electrodes.

8. The lithium ion secondary battery according to claim 1, wherein the third current collector comprises copper, and the electrolyte comprises a sulfide solid electrolyte.
